(19) United States
(12) Patent Application Publication
(10) Pub. No.: US 2026/0039149 A1
(43) Pub. Date: Feb. 5, 2026

(54) NEW COMPENSATION TOPOLOGIES FOR WIRELESS POWER TRANSFER SYSTEMS

(71) Applicant: Auckland UniServices Limited, Auckland (NZ)

(72) Inventors: You-Chun HUANG, Kaohsiung City (TW); Udaya Kumara MADAWALA, Auckland (NZ)

(21) Appl. No.: 19/350,592

(22) Filed: Oct. 6, 2025

Related U.S. Application Data
(63) Continuation of application No. PCT/IB2024/053325, filed on Apr. 5, 2024.

(30) Foreign Application Priority Data
Apr. 5, 2023 (NZ) 798881

(51) Int. Cl. H02J 50/12; H02J 50/90

(52) U.S. Cl. CPC H02J 50/12; H02J 50/90

(57) ABSTRACT

Presented is a wireless power transfer (inductive power transfer) apparatus and systems for application to wireless power transfer compensation networks and control of wireless power transfer circuits.

### FIELD

This disclosure relates to wireless power transfer (also referred to as inductive power transfer) apparatus and systems and has particular, but not necessarily sole, application to wireless power transfer compensation networks and control of wireless power transfer circuits.

### BACKGROUND

Inductive power transfer (IPT) technology is widely used to wirelessly supply power for numerous applications that range from low to very high-power levels. These include medical implants, portable devices and electric vehicles. IPT enables wireless power transfer through magnetic coupling and without any physical contact.

In IPT systems, wireless power transfer takes place from a primary magnetic coupling apparatus, often referred to as a primary pad to a secondary magnetic coupling apparatus, which is often referred to as a secondary pad. The two pads each have at least one coil for generating or receiving magnetic flux and are separated by a gap of non-conducting material, typically an airgap, but magnetically coupled through mutual inductance (M) between the coils. The primary pad is usually driven by an inverter and the secondary pad may have a rectifier and/or regulator to provide power to a load, for example a battery when the system is being used in a charging application. Because the airgap is usually large, typical IPT systems have weak magnetic coupling and thus reactive power (VAR) compensation circuits are required to achieve efficient power transfer. The VAR compensation is provided by using a network comprising combinations of capacitors and inductors, configured to resonate with the coil inductance of each pad, on both sides of the system.

When the two pads are aligned and the system is fully tuned so that it resonates, then power transfer occurs at the resonant frequency and unity power factor. However, any misalignments between the two pads will significantly impact the mutual coupling Mand system parameters, which in turn affects the overall performance, particularly in the output power, efficiency, power factor, and electromagnetic interference (EMI). This is a significant problem in the provision of commercially viable wireless power transfer systems.

### Object

It is an object of the present disclosure to provide a wireless power circuit or system, or a control system or method for a wireless power circuit or system, which addresses one or more of the problems of known apparatus or methods, or which at least provides a useful alternative to known apparatus or methods.

### Summary

In one aspect a wireless power transfer resonant compensation circuit is provided comprising a power transfer coil and a plurality of inductive and capacitive components, the circuit being configured to operate at a plurality of different resonant operating frequencies whereby the circuit forms a plurality of parallel or series tuned compensation networks, each of the tuned compensation networks forming at a different resonant operating frequency.

The circuit may optionally be configured to provide a plurality of parallel tuned compensation networks, each of the parallel tuned compensation networks forming at a different resonant operating frequency.

Alternatively, or additionally, the circuit may be configured to provide a plurality of series tuned compensation networks, each of the series tuned compensation networks forming at a different resonant operating frequency.

The circuit may comprise a series connected tank and a parallel branch having a tank. A series connected inductor may also be present.

The series connected tank may optionally be configured to provide a first capacitive impedance at one operating frequency to form a first parallel compensation network, and provide a second capacitive impedance at another operating frequency to form a second parallel compensation network.

The circuit may further optionally comprise a parallel branch having two tanks. The tanks may be connected in series. The tanks may be parallel tanks, for example a capacitor in parallel with an inductor. Optionally, one of the tanks circuits is configured to form an infinite impedance at one operating frequency to form a first series compensation network, and the other of the tanks circuits is configured to form an infinite impedance at another operating frequency to provide a second series compensation network.

The circuit may be used as part of a primary apparatus of a wireless power transfer network or a secondary apparatus of a wireless power transfer network. Variants of the circuit, optionally including further components, may be used as compensation networks or circuits in both wireless power transfer primary and secondary apparatus or circuits.

A wireless power transfer primary or secondary circuit comprising the resonant compensation circuit above is also provided, as is a wireless power transfer system comprising a primary and/or secondary which includes a compensation circuit as described above. The wireless power transfer system may be bidirectional.

The secondary apparatus or circuit may include a converter to actively control an output. The converter may be configured to provide impedance matching. The converter may be controlled to match an impedance of the secondary to an impedance of a primary circuit with which it may be coupled.

In another aspect a wireless power transfer system comprising a primary resonant compensation circuit and a secondary resonant compensation circuit is provided, the system being configured to operate at a plurality of different operating frequencies, each circuit being resonant at each operating frequency and wherein the primary circuit forms a first series tuned compensation network at a first of the operating frequencies and forms a first parallel tuned compensation network at a second of the operating frequencies, and the secondary circuit forms a first parallel tuned compensation network at the first operating frequency and forms a second parallel tuned compensation network at the second of the operating frequencies.

Optionally, the primary forms a second series tuned network at a third operating frequency and the secondary forms a first series tuned network at the third frequency.

The secondary may also optionally form a second series tuned network at a fourth frequency and the primary forms a second parallel tuned network at the fourth frequency.

In another aspect a wireless power transfer system comprising a primary resonant compensation circuit and a secondary resonant compensation circuit is provided, the system being configured to operate at a plurality of different operating frequencies, each circuit being resonant at each operating frequency and wherein the system forms at least S-P and P-P compensation networks.

In another aspect an IPT circuit controller is provided configured to control a converter of an IPT circuit to an operating frequency dependent upon a coupling factor of the circuit, wherein the controller controls the operating frequency to one of a plurality of discrete operating frequencies at which the primary circuit is tuned to be resonant.

Optionally, each operating frequency to selected to implement a different compensation topology.

The controller may be further configured to control a phase shift angle of the converter dependent on the coupling factor. The controller may control or select the operating frequency to control or lower or reduce or minimize current in the circuit, for example the primary circuit.

In another aspect a method of controlling an IPT circuit is provided comprising receiving an indication of coupling factor, select an operating frequency from a plurality of discrete operating frequencies at which the circuit is tuned to be resonant dependent on the coupling factor, and controlling the circuit at the selected operating frequency.

Each operating frequency may be selected to implement a different compensation topology.

A controller configured to implement the method above is also provided.

In another aspect a wireless power transfer resonant circuit is provided, comprising:
a power transfer coil;
a compensation network connected between the power transfer coil and a power input or power output, the compensation network being configured to resonate with the power transfer coil at a first resonant operating frequency and a second resonant operating frequency;
the compensation network comprising a first tank circuit connected in series with the power transfer coil and a second tank circuit connected in parallel with the power transfer coil; wherein
the circuit forms a first parallel or series tuned compensation network topology at the first resonant operating frequency and a second parallel or series tuned compensation network topology at the second resonant operating frequency.

Optionally, the circuit forms a first parallel tuned compensation network topology at the first resonant operating frequency and a second parallel tuned compensation network topology at the second resonant operating frequency.

Optionally, the compensation network further comprises a series inductor connected in series with the first tank circuit, and the second tank circuit is connected between the first tank circuit and the series inductor.

Optionally, the first tank circuit or the second tank circuit is configured to have a capacitive impedance at the first resonant operating frequency.

Optionally, the first tank circuit or the second tank circuit is configured to have a capacitive impedance at the second resonant operating frequency.

Optionally, a capacitor Css connected in series with the first tank circuit.

Optionally, a capacitor Csp connected in series with the second tank circuit.

Optionally, a third tank circuit connected in series with the first tank circuit and a fourth tank circuit connected in series with the second tank circuit.

Optionally, a fourth tank circuit connected in series with the second tank circuit and wherein the circuit forms a first series tuned compensation network topology at the first resonant operating frequency and a second series tuned compensation network topology at the second resonant operating frequency.

Optionally, one of the second or fourth tank circuits is configured to form an infinite impedance at the first resonant operating frequency to form the first series tuned compensation network, and the other of the second or fourth tank circuits is configured to form an infinite impedance at the second resonant operating frequency to provide the second series tuned compensation network.

Optionally, one or more of the tank circuits comprises a parallel tank.

In another aspect a wireless power control apparatus for controlling a wireless power transfer system is provided, the control apparatus comprising:
an input configured to receive a signal representing a coupling factor between a primary circuit and a secondary circuit of the wireless power transfer system;
a control circuit configured to control a converter of the primary circuit and/or secondary circuit to an operating frequency dependent upon the coupling factor, wherein the controller circuit controls the operating frequency to one of a plurality of discrete operating frequencies at which the wireless power transfer system is tuned to be resonant.

Optionally, each operating frequency is selected to implement a different compensation topology in the primary and secondary circuits.

Optionally, a phase shift angle of the converter is controlled dependent on the coupling factor.

In another aspect a method of controlling a wireless power transfer circuit is provided, the method comprising:
determining a coupling factor for the wireless power transfer circuit;
selecting an operating frequency from a plurality of discrete operating frequencies at which the circuit is tuned to be resonant dependent on the coupling factor, and;
controlling the circuit at the selected operating frequency.

Optionally, each operating frequency to selected to implement a different compensation topology.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

As used herein the term “and/or” means “and” or “or”, both. As used herein “(s)” following a noun means the plural and/or singular forms of the noun. The term “comprising” as used in this specification means “consisting at least in part of”. When interpreting statements in this specification which include that term, the features prefaced by that term in each statement all need to be present, but the other features can also be present. Related terms such as “comprise” and “comprised” are to be interpreted in the same manner. The entire disclosures of all applications, patents and publications, cited above and below, if any, are hereby incorporated by reference.

In the following description, specific details are given to provide a thorough understanding of the embodiments. However, it will be understood by one of ordinary skill in the art that the embodiments may be practiced without these specific details. For example, modules, including those in the form of control modules or circuits, software modules, functions, circuits, etc., may be shown in block diagrams in order not to obscure the embodiments in unnecessary detail. In other instances, well-known modules, structures and techniques may not be shown in detail in order not to obscure the embodiments.

### DRAWING DESCRIPTION

FIG. 1 is a circuit diagram of a wireless power transfer system;

FIG. 2 is a circuit diagram of a series compensation network;

FIG. 3 is a circuit diagram of a parallel compensation network;

FIG. 4 (a) is a circuit diagram of a wireless power transfer system;

FIG. 4 (b) is an equivalent circuit diagram for the system of FIG. 4 (a) at a first operating frequency;

FIG. 4 (c) is an equivalent circuit diagram for the system of FIG. 4 (a) at a second operating frequency;

FIGS. 5, 6, 7, and 8 are circuit diagrams of a further wireless power transfer system;

FIGS. 9, 10, 11, 12, and 13 are circuit diagrams of a still further wireless power transfer system;

FIG. 14 shows waveforms for phase-shift modulation for a converter used in a system according to FIG. 4 (a), or FIG. 5, or FIG. 9 or FIG. 15;

FIG. 15 is a circuit diagram of a wireless power transfer system including a controller;

FIG. 16 (a) shows simulated waveforms of a system according to FIG. 4 (a) when S-P compensated system (79 kHz) for k=0.36;

FIG. 16 (b) shows simulated waveforms of a system according to FIG. 4 (a) when S-P compensated system (79 kHz) for k=0.24;

FIG. 17 (a) shows simulated waveforms of system according to FIG. 4 (a) when P-P compensated system (85 kHz) for k=0.15;

FIG. 17 (b) shows simulated waveforms of system according to FIG. 4 (a) when P-P compensated system (85 kHz) for k=0.22;

FIG. 18 shows plots of Output power and lₚᵢ as k varies for the simulations shown in FIGS. 16 and 17.

### DETAILED DESCRIPTION

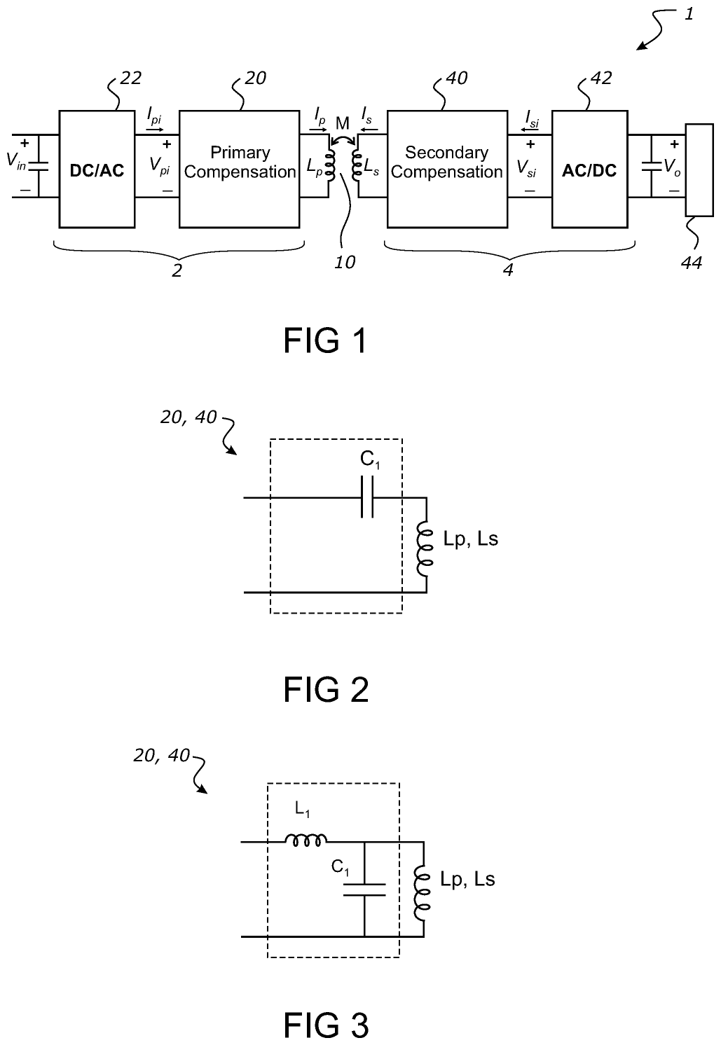

Referring to FIG. 1, a wireless power transfer system is shown, generally referenced 1. The system 1 comprises a primary side 2 and a secondary side 4. The primary 2 has a coil Lp which is electrically connected to compensation network 20 which is in turn driven or energised by a converter 22 from a primary power source Vin. Converter 22 is configured to provide an alternating current power source in the coil Lp at a selected operating frequency to create a magnetic field for power transfer. The compensation circuit 20 is configured to resonate with coil Lp at the operating frequency of converter 22. Similarly, the secondary side 4 has a coil Ls which is electrically connected to compensation network 40. Coil Ls is tuned by compensation circuit 40 to be resonant at the operating frequency. The compensation network 40 is connected to a rectifier and/or regulator such as converter 42 to provide an output power supply Vo for connection to a load 44. If the system 1 is being used to charge a vehicle for example, then load 44 may comprise a vehicle battery. The coils Lp and Ls are separated by a gap 10. In many applications the alignment (for example the relative position of the central axes of the coils) and/or separation (i.e. the extent or length of the gap 10 between the coils) of coils Lp and Ls will vary in use. For example, the secondary 4 may be provided on or as part of a vehicle and coil Ls on the vehicle may be misaligned with coil Lp from time to time as the vehicle is parked or otherwise moved relative to a structure such as a floor on or in which coil Lp is provided. The system may be bi-directional i.e. the secondary may be used as a primary and vice versa.

Each of the primary side 2 and secondary side 4 may be provided as a complete apparatus or may be an assembly of modules or components. For example, in some embodiments or examples the coils Lp or Ls may be provided as separate components (for example in the form of pads) for electrical connection to the compensation circuits and the inverters/rectifiers. In other embodiments or examples, the compensation network components may be provided separately as circuits ready for connection to the coils Lp and/or Ls. In an embodiment the compensation network circuitry is supplied connected to the coils Lp and/or Ls, and these modular units are then connected separately to inverters/rectifiers and/or supplies/loads.

FIGS. 2 and 3 show simplified circuit diagrams of two general forms of compensation network topologies 20. Although these are shown in the context of the primary coil Lp, they may equally be used in the secondary, i.e. they may instead be connected to secondary coil Ls.

The topology shown in FIG. 2 uses a capacitor C1 connected in series with the power transfer coil Lp, so it is referred to as a series (or “S”) compensation circuit or series compensation topology. Series compensation topologies are sometimes referred to as LC compensation topologies.

The topology shown in FIG. 3 uses a capacitor C1 connected in parallel with the power transfer coil Lp, so it is referred to as a parallel (or “P”) compensation circuit or parallel compensation topology. Parallel topologies are sometimes referred to as LCL compensation topologies as they may form a T network having two inductors in series and a capacitor in a parallel branch from the node at which the inductors are connected. Compensation circuit topologies, whether series or parallel, are typically designed to resonate at a single operating frequency for a specific system 1.

The primary compensation 20 and secondary compensation 40 may be both series or parallel, or there may be series compensation on the primary and parallel compensation on the secondary, or vice-versa. For purposes of simplicity in this disclosure, series compensation will be referred to as “S” and parallel compensation will be referred to as “P”. Therefore, series compensation on both the primary and secondary sides will be referred to as S-S compensation, parallel compensation on both the primary and secondary sides will be referred to as P-P compensation, series compensation on the primary and parallel compensation on the secondary will be referred to as S-P compensation, and parallel compensation on the primary side and series compensation on the secondary side will be referred to as P-S compensation.

The power output by the secondary is dependent upon the compensation topology that is used. The relationships are shown mathematically below with reference to the voltages, currents, and mutual inductance M as shown in FIG. 1.

With S-S compensation the primary and secondary coils Lp and Ls are each are fully compensated by a series capacitor. Under the fully tuned condition, with losses neglected, the output power (P_{oS-S}) is given by

$${P}_{oS - S} = {V}_{{p}_{i}}^{2} \frac{{R}_{Leq}}{{( {ω}_{S} M )}^{2}}$$

where Vₚᵢ is the primary input voltage, R_{Leg} is the equivalent AC load resistance, and ω_{S} is angular frequency (2πfₛ).

S-P compensation uses a series capacitor on the primary and a parallel capacitor on the secondary. Under the fully tuned condition, the output power (P_{oS-P}) of S-P compensation, is given by

$${P}_{oS - P} = {V}_{{p}_{i}}^{2} \frac{{L}_{S}^{2}}{{M}^{2} {R}_{Leq}}$$

P-P compensation compensates the primary and secondary coils Lp and Ls with parallel capacitors. Under the fully tuned condition, the output power (P_{oP-P}) of P-P compensation can be obtained by

$${P}_{oP - P} = {I}_{{p}_{i}}^{2} \frac{{M}^{2} {R}_{Leq}}{{L}_{S}^{2}}$$

where lₚᵢ is the primary input current.

A similar analysis can be provided for the output power of a P-S compensated system.

From the above, as M varies with misalignment and/or separation distance between coils Lp and Ls, it can be seen that the output power varies differently with different compensation topologies. For example, there is an opposite trend in power output with variation in M between for example S-P and P-P compensation. With S-P compensation as M decreases then output power increases, whereas the opposite occurs with P-P compensation. Therefore, if a system 1 could be operated with different compensation topologies that are selected dependent on M, then improved power output could be achieved for misalignments and separations of the power transfer coils Lp and Ls.

The present disclosure provides compensation circuit topologies that can be operated as S or P topologies dependent on system operating frequency, i.e. as an S topology at one operating frequency and as a P topology at another operating frequency.

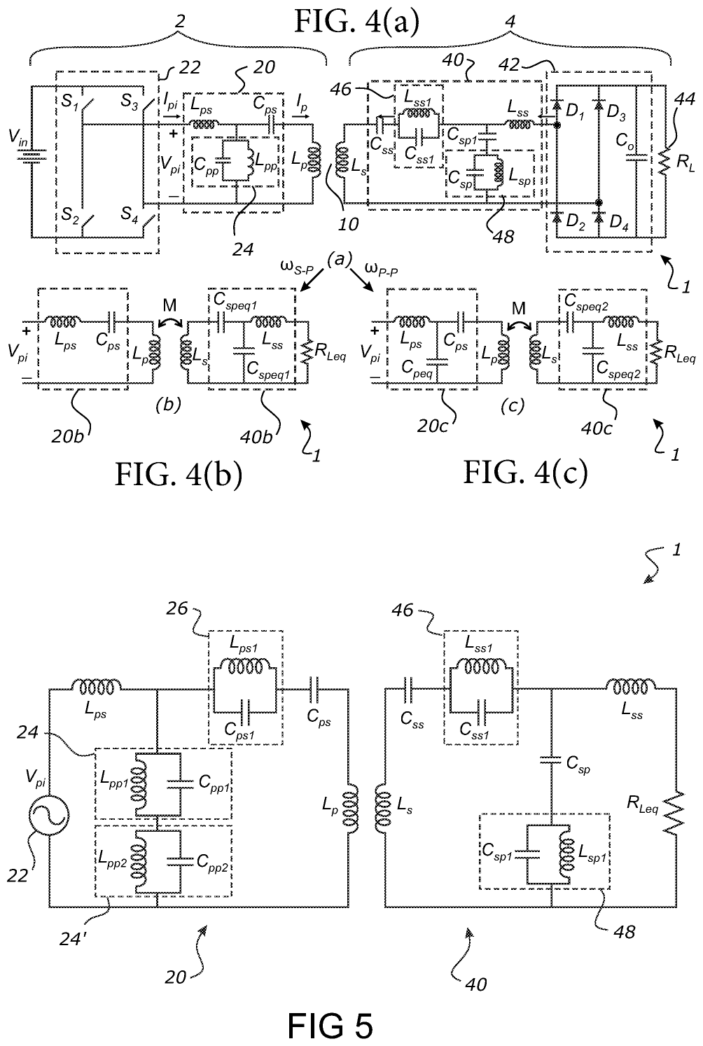

FIG. 4 (a) illustrates an example of a topology that can be operated as S-P compensated at a first operating frequency and P-P compensated at a second operating frequency. In this example inverter 22 comprises an H-bridge converter, which consists of four power switches S₁, S₂, S₃, and S₄, connected between input DC voltage Vin and the primary compensation 20 and produces alternating voltage Vₚᵢ. The primary input current lₚᵢ is the current feeding the compensation network 20.

The primary compensation topology 20 may include a series inductor Lₚₛ, and a series capacitor Cₚₛ. A parallel branch (i.e. a branch in parallel with the coil Lp) has a tank circuit 24 (a parallel connected tank) comprising capacitor Cₚₚ and inductor Lₚₚ. In the example shown, the parallel branch 24 is provided between inductor Lₚₛ and capacitor Cₚₛ, so inductor Lₚₛ is provided at the input to the compensation network between the parallel branch 24 and the converter 22, and capacitor Cₚₛ, is provided between branch 24 and coil Lp. Other arrangements of specific components are possible in accordance with the principles disclosed further below.

On the secondary 4, a series capacitor Cₛₛ and series inductor Lₛₛ are provided, with a series connected first tank 46 comprising and an inductor Lₛₛ₁ with a parallel capacitor Cₛₛ₁. A parallel branch is provided having parallel connected second tank 48 comprising inductor Lₛₚ which is connected in parallel with a capacitor Cₛₚ. In this example a further capacitor Cₛₚ₁ is connected in series with tank 48 to complete the parallel branch. In this example the tank circuits 46 and 48 are provided between Lₛₛ and Cₛₛ, so that series inductor Lₛₛ is provided between the parallel branch and the output of the compensation circuit, but other arrangements are possible. For the output power rectification 42, a rectifier, which is composed of four diodes D₁, D₂, D₃ and D₄ transfers the AC to DC. Furthermore, a filter capacitor Cₒ is connected between the rectifier and load resistor R_{L} 44 to stabilize the output voltage.

As mentioned above, the compensation circuits 20 and 40 of FIG. 4 (a) can provide different system compensation topologies. To explain the function of the circuits reference is now made to FIGS. 4 (b) and 4 (c). FIG. 4 (b) is the equivalent circuit when the system operates at frequency (ωS-P), forming a S-P compensated system. The network 20b is the equivalent circuit for network 20. Similarly, the network 40b is the equivalent circuit for network 40. To realize this, the components Lₚₚ, Cₚₚ are selected or configured to resonate with each other. Therefore, at a first frequency components Lₚₚ, Cₚₚ resonate which creates the appearance of a very high impedance (tending to infinity) and thus effectively presents an open circuit across tank 24. This effectively removes the parallel branch so that the topology appears to the system as a series compensation topology. It will be understood that in other examples the tank 24 may comprise a series connected capacitor and inductor.

For the secondary circuit 40, the impedance of the branch formed by Cₛₛ, Lₛₛ₁, and Cₛₛ₁ is the same as that of the equivalent capacitor C_{sseq1}. Similarly, the impedance of the branch formed by Cₛₚ₁, Lₛₚ, and Cₛₚ is the same as that of the equivalent capacitor C_{speq1}. Therefore, tanks 46 and 48 are selected or configured to provide impedances which augment those of Cₛₛ, Lₛₛ and Cₛₚ₁ as appropriate to enable a parallel compensation network at the first operating frequency. To ensure that the system resonates at ωS-P, the values of the tuning components should be selected in accordance with the condition given by:

$${ω}_{S - P} = \sqrt{\frac{1}{{L}_{pp} {C}_{pp}}} = \sqrt{\frac{1}{( {L}_{ps} + {L}_{p} ) {C}_{ps}}} \sqrt{\frac{1}{( {L}_{s} - {L}_{ss} ) {C}_{sseq 1}}} \sqrt{\frac{1}{{L}_{ss} {C}_{speq 1}}}$$

FIG. 4 (c) shows the equivalent circuit when the system operates at a second operating frequency (ωP-P), forming a P-P compensated system. In this mode, the branch having tank 24 formed by Lₚₚ and Cₚₚ is configured to provide a required capacitance equivalent to C_{peq} on the primary. Thus, the parallel branch is seen by the compensation network and can operate as a parallel compensation topology. On the secondary, Cₛₛ, Lₛₛ₁, and Cₛₛ₁ are considered as the equivalent capacitor (C_{sseq2}) and the impedance of the branch formed by Cₛₚ₁, Lₛₚ, and Cₛₚ is equivalent to that of C_{speq2}. Therefore, tanks 46 and 48 are selected or configured to provide impedances which augment, reduce or modify the effect of those of Cₛₛ, Lₛₛ and Cₛₚ₁ as appropriate to enable a parallel compensation network at the second operating frequency. To ensure that the system resonates at ωP-P, the values of the tuning components must be selected in accordance with the condition given by:

$${ω}_{P - P} = \sqrt{\frac{1}{{L}_{ps} {C}_{peq}}} = \sqrt{\frac{1}{( {L}_{D} + {L}_{DS} ) {C}_{DS}}} \sqrt{\frac{1}{( {L}_{s} - {L}_{ss} ) {C}_{sseq 2}}} \sqrt{\frac{1}{{L}_{ss} {C}_{speq 2}}}$$

Table 1 shows parameters for an exemplary system according to the circuits shown in FIG. 4 (a).

| Parameter | Symbol | Value | Unit |
|---|---|---|---|
| Input DC voltage | Vᵢₙ | 160 | V |
| S-P operation frequency | f_{S-P} | 79 | kHz |

TABLE 1

| Parameter | Symbol | Value | Unit |
|---|---|---|---|
| P-P operation frequency | f_{P-P} | 85 | kHz |
| Normalization frequency | f_{T} | 82 | kHz |
| Load resistance | R_{L} | 45 | Q |
| Primary pad self- | Lₛ | 200 | μH |
| inductance | | | |
| Primary series inductor | Lₚₛ | 14.6 | μH |
| Primary parallel inductor | Lₚₚ | 2.3 | μH |
| Primary parallel capacitor | Cₚₚ | 1.76 | μF |
| Primary series capacitor | Cₚₛ | 18.9 | nF |
| Secondary pad self- | Lₛ | 200 | μH |
| inductance | | | |
| Secondary series inductors | Lₛₛ, Lₛₛ₁ | 100, 0.5 | μH |
| Secondary parallel inductor | Lₛₚ | 0.5 | μH |
| Secondary parallel | Cₛₚ, Cₛₚ₁ | 0.037, 7.7 | μF |
| capacitors | | | |
| Secondary series capacitors | Cₛₛ, Cₛₛ₁ | 0.037, 7.7 | μF |

The proposed topology can be switched between S-P and P-P compensation by simply adjusting the operating frequency without any other modifications. It can be seen that the secondary compensation network 40 provides a first parallel compensation network at a first operating frequency that allows power transfer with a primary having a series compensation network, and provides a second parallel compensation network at a second operating frequency that allows power transfer with a primary having a parallel compensation network. It will also be understood that a similar compensation network can be provided on the primary.

Further examples will now be described with reference to FIGS. 5-8 and 9-13, which use compensation networks that are configured to operate at a plurality of different resonant operating frequencies whereby the circuits form a plurality of series tuned compensation networks or parallel tuned compensation networks, each of the series tuned compensation networks or parallel tuned compensation networks forming at a different resonant operating frequency.

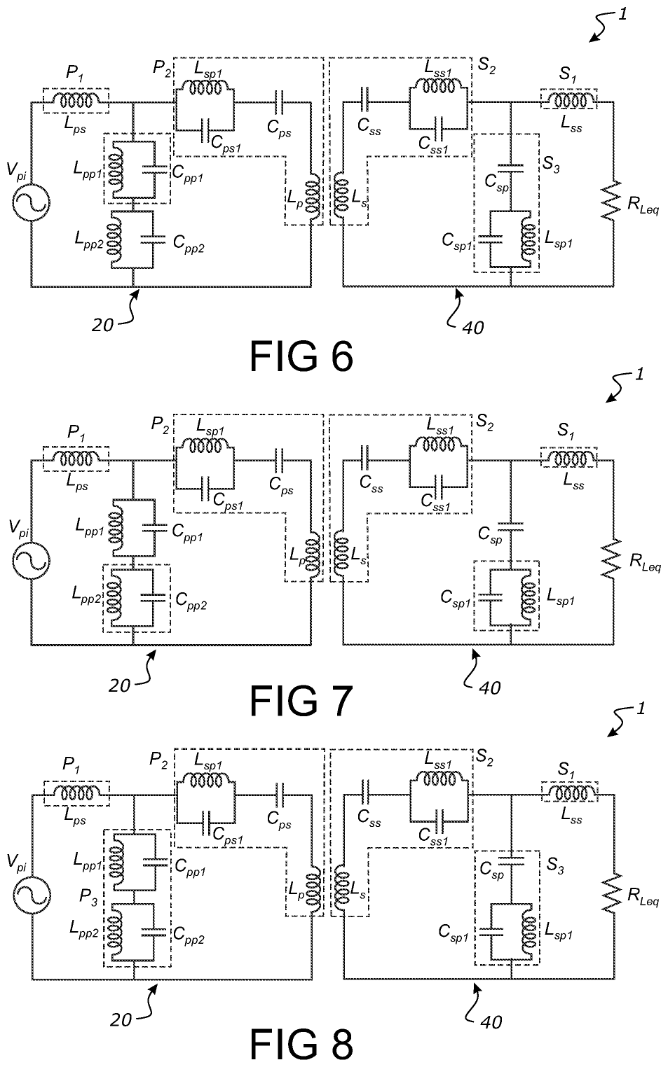

Referring to FIG. 5, a system 1 having a primary topology 20 and a secondary topology 40 is shown that can be operated as S-S, S-P, or P-P compensated depending on the frequency of the operation, for example S-P compensation at a first operating frequency ωS-P, S-S compensation at a second operating frequency ωS-S, and P-P compensation at a third operating frequency ωP-P. As with the FIG. 4 (a) topology the primary is driven by a converter or inverter 22 which is represented in FIG. 5 (and in FIGS. 6-13) by Vₚᵢ. The secondary topology 40 is substantially the same as that of FIG. 4 (a), and has the same reference numerals. The primary topology has a first tank circuit 26, a second tank circuit 24 and a further (which may be referred to as a fourth) tank circuit 24′ connected in series with the second tank 24 in the parallel branch i.e. in the branch which is connected in parallel with the primary power transfer coil Lₚ. The tanks 24 and 24′ in this example comprise parallel connected inductors and capacitors (Lₚₚ₁, Cₚₚ₁, Lₚₚ₂ and Cₚₚ₂). The parallel branch consists of the two resonant tanks 24 and 24′ which in this example are connected in series with each other. This allows one of tank circuits 24 or 24′ to be tuned to an open circuit at one operating frequency to form a first series compensated network, and the other of tank circuits 24 or 24′ to be tuned to an open circuit at another operating frequency to form a second series compensated network.

Enablement of practical circuits is disclosed below with reference to FIGS. 6-8 in which reactive components of topologies 20 and 40 are identified individually or by group P₁-P₃ in the primary topology 20 and S₁-S₃ in the secondary topology 40.

Referring to FIG. 6, S-P operation mode at a first operating frequency (f_{S-P}, ω_{SP}) is achieved.

For the primary this is done by making the impedance of (P1+P2)=zero, so:

$${ω}_{sp} {L}_{ps} - \frac{{ω}_{sp} {L}_{ps 1}}{{ω}_{sp}^{2} {L}_{ps 1} {C}_{ps 1} - 1} - \frac{1}{{ω}_{sp} {C}_{ps}} + {ω}_{sp} {L}_{p} = 0$$

And making the impedance of tank 24 (Lₚₚ₁ and Cₚₚ₁) infinity:

$$\frac{{ω}_{sp} {L}_{pp 1}}{1 - {ω}_{sp}^{2} {L}_{pp 1} {C}_{pp 1}} = ∞ = > 1 - {ω}_{sp}^{2} {L}_{pp 1} {C}_{pp 1} = 0$$

For the secondary, the impedances of S₁=S₂=S₃. Hence:

$${ω}_{sp} {L}_{ss} = {ω}_{sp} {L}_{s} - \frac{1}{{ω}_{sp} {C}_{ss}} - \frac{{ω}_{sp} {L}_{ss 1}}{{ω}_{sp}^{2} {L}_{ss 1} {C}_{ss 1} - 1} = \frac{1}{{ω}_{sp} {C}_{sp}} + \frac{1}{{ω}_{sp} {C}_{1 ( sp )}}$$

where,

$${C}_{1 ( sp )} = \frac{{ω}_{sp}^{2} {L}_{sp 1} {C}_{sp 1} - 1}{{ω}_{sp}^{2} {L}_{sp 1}}$$

Reference is now made to FIG. 7 for S-S operation at operating frequency f_{S-s}, ω_{SS}). For the primary, the impedance of (P₁+P₂) is zero, so:

$${ω}_{sp} {L}_{ps} - \frac{{ω}_{ss} {L}_{ps 1}}{{ω}_{ss}^{2} {L}_{ps 1} {C}_{ps 1} - 1} - \frac{1}{{ω}_{ss} {C}_{ps}} + {ω}_{ss} {L}_{p} = 0$$

And the impedance of tank 24′ (Lₚₚ₂ and Cₚₚ₂) is infinity:

$$\frac{{ω}_{ss} {L}_{pp 2}}{1 - {ω}_{ss}^{2} {L}_{pp 2} {C}_{pp 2}} = ∞ = > 1 - {ω}_{ss}^{2} {L}_{pp 2} {C}_{pp 2} = 0$$

For the secondary, the impedance of (S₁+S₂) is zero:

$${ω}_{ss} {L}_{ss} - \frac{{ω}_{ss} {L}_{ss 1}}{{ω}_{ss}^{2} {L}_{ss 1} {C}_{ss 1} - 1} - \frac{1}{{ω}_{ss} {C}_{ss}} + {ω}_{ss} {L}_{s} = 0$$

And the impedance of tank 48 (Lₛₚ₁ and Cₛₚ₁) is infinity:

$$\frac{{ω}_{ss} {L}_{sp 1}}{1 - {ω}_{ss}^{2} {L}_{sp 1} {C}_{sp 1}} = ∞ = > 1 - {ω}_{ss}^{2} {L}_{sp 1} {C}_{sp 1} = 0$$

Reference is now made to FIG. 8 for P-P operation at operating frequency (f_{P-P} and ω_{PP}).

For the primary, the impedance of P₁=P₂=P₃ so:

$${ω}_{pp} {L}_{ps} = {ω}_{pp} {L}_{p} - \frac{1}{{ω}_{pp} {C}_{ps}} - \frac{{ω}_{pp} {L}_{ps 1}}{{ω}_{pp}^{2} {L}_{ps 1} {C}_{ps 1} - 1} = \frac{1}{{ω}_{pp} {C}_{p 1 ( pp )}} + \frac{1}{{ω}_{pp} {C}_{p 2 ( pp )}}$$

$$where$$

$${C}_{p 1 ( pp )} = \frac{{ω}_{pp}^{2} {L}_{pp 1} {C}_{pp 1} - 1}{{ω}_{pp}^{2} {L}_{pp 1}}$$

$$and$$

$${C}_{p 2 ( pp )} = \frac{{ω}_{pp}^{2} {L}_{pp 2} {C}_{pp 2} - 1}{{ω}_{pp}^{2} {L}_{pp 2}}$$

For the secondary, the impedance of S₁=S₂=S₃ so:

$${ω}_{ss} {L}_{ss} = {ω}_{pp} {L}_{s} - \frac{1}{{ω}_{pp} {C}_{ss}} - \frac{{ω}_{pp} {L}_{ss 1}}{{ω}_{pp}^{2} {L}_{ss 1} {C}_{ss 1} - 1} = \frac{1}{{ω}_{pp} {C}_{sp}} + \frac{1}{{ω}_{pp} {C}_{s 1 ( pp )}}$$

$$where$$

$${C}_{s 1 ( pp )} = \frac{{ω}_{pp}^{2} {L}_{sp 1} {C}_{sp 1} - 1}{{ω}_{pp}^{2} {L}_{sp 1}}$$

Component values for the circuit of FIG. 5 may be determined for example by setting the frequency of S-P, S-S, and P-P as 79 kHz, 85 kHz, and 90 kHz, respectively.

On the primary, by using the formulas above and choosing Lₚ as 200 μH and Lₚₛ as 20 μH, the value of Lₚₛ₁, Cₚₛ₁, and Cₚₛ can be obtained. Then, with choosing Lₚₚ₁ as 1 μH, the value of, Cₚₚ₁, Lₚₚ₂, and Cₚₚ₂ can be obtained.

On the secondary, by choosing Lₛₛ as 200 μH and L_{SS} as 20 μH, the value of C_{SS}, L_{SS1}, and C_{SS1} can be obtained. Then, the value of Cₛₚ, Lₛₚ₁, and Cₛₚ₁ can be obtained. Table 2 below provides calculated component values for the circuit of FIG. 5.

TABLE 2

| Parameter | Symbol | Value | Unit |
|---|---|---|---|
| Rated power | P_{rated} | 1 | kW |
| Input DC voltage | Vᵢₙ | 160 | V |
| S-P operation frequency | f_{S-P} | 79 | kHz |
| S-S operation frequency | f_{S-S} | 85 | kHz |
| P-P operation frequency | f_{P-P} | 90 | kHz |
| Rated power | P_{rated} | 1 | kW |
| Primary pad self- | Lₚ | 200 | μH |
| inductance | | | |
| Primary series | Lₚₛ, Lₚₛ₁ | 20, 0.78 | μH |
| inductor | | | |
| Primary series | Cₚₛ, Cₚₛ₁ | 0.018, 4.65 | μF |
| capacitor | | | |
| Primary parallel | Lₚₚ₁, Lₚₚ₂ | 1, 2.02 | μH |
| inductor | | | |
| Primary parallel | Cₚₚ₁, Cₚₚ₂ | 4.06, 1.74 | μF |
| capacitor | | | |
| Secondary pad | L_{S} | 200 | μH |
| self-inductance | | | |
| Secondary series | L_{SS}, L_{SS1} | 20, 2.55 | μH |
| inductors | | | |
| Secondary series | C_{SS}, C_{SS1} | 0.019, 1.5 | μF |
| capacitors | | | |
| Secondary parallel | Lₛₚ₁ | 0.33 | μH |
| inductor | | | |
| Secondary parallel | Cₛₚ, Cₛₚ₁ | 0.18, 10.63 | μF |
| capacitors | | | |

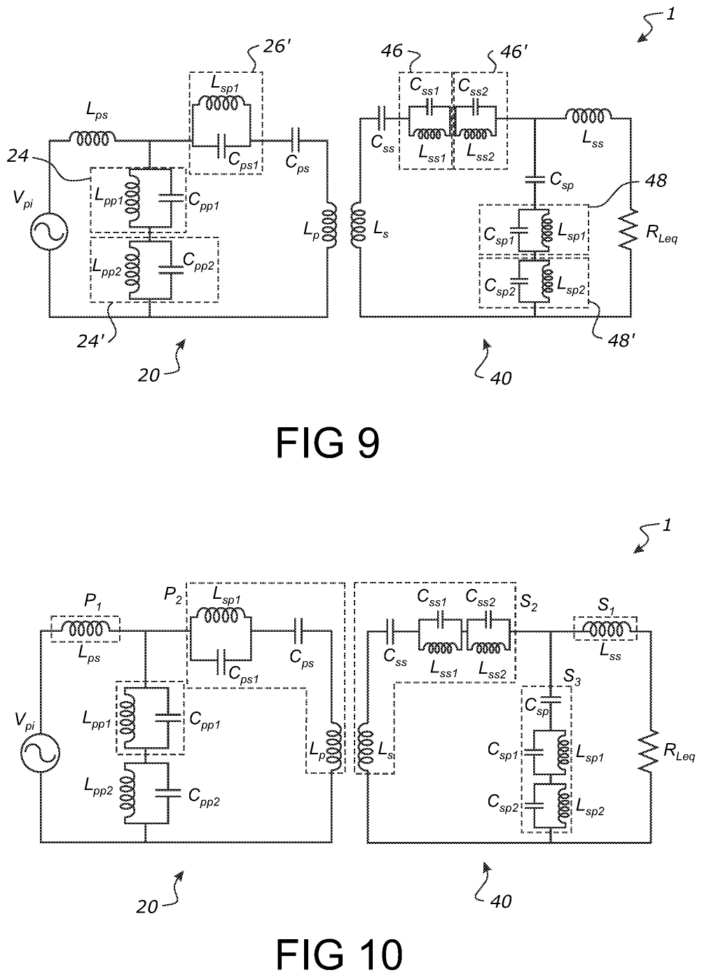

Referring to FIG. 9, a system 1 having a primary topology 20 and a secondary topology 40 is shown that can be operated as S-S, S-P, P-S, or P-P compensated depending on the frequency of the operation, for example S-P compensation at a first operating frequency ωS-P, P-S compensation at a second operating frequency ωP-S, S-S compensation at a third operating frequency ωS-S, and P-P compensation at a fourth operating frequency ωP-P. As with the FIG. 4 (a) topology the primary is driven by a converter or inverter 22 which is represented by Vₚᵢ. The primary topology 20 is substantially the same as that of FIG. 5, and has the same reference numerals. The secondary compensation topology is similar to that of FIG. 4 (a) and FIG. 5, including L_{SS} and C_{SS}, with C_{SS} being in series with a first tank 46 comprising L_{SS1} and C_{SS1} (which are connected in parallel in this example) and another tank 46′ (which may be referred to as a third tank) comprising L_{SS2} and C_{SS2} (which are connected in parallel in this example). Tanks 46 and 46′ are connected in series. For the parallel branch (which is connected in parallel with the secondary power coil L_{S}), there are two tanks 48 and 48′ (which may be referred to as the second and fourth tanks). In this example, these are connected in series with each other to form the parallel branch with Cₛₚ which may be optional. The components of the tanks comprise Lₛₚ₁ connected in parallel with Cₛₚ₁ to form tank 48, and Lₛₚ₂ connected in parallel with Cₛₚ₂ to form tank 48′. This allows one of tank circuits 48 or 48′ to be tuned to an open circuit at one operating frequency to form a first series compensated network, and the other of tank circuits 48 or 48′ to be tuned to an open circuit at another operating frequency to form a second series compensated network. Enablement of practical circuits is disclosed below with reference to FIGS. 10-13 in which reactive components of topologies 20 and 40 are identified individually or by group P₁-P₃ in the primary topology 20 and S₁-S₃ in the secondary topology 40.

Referring to FIG. 10, an S-P mode of operation at an operating frequency (fₛ₋ₚ, ωSP) is achieved for the primary 20 by making impedance of (P₁+P₂)=zero:

$${ω}_{sp} {L}_{ps} = \frac{{ω}_{sp} {L}_{ps 1}}{{ω}_{sp}^{2} {L}_{ps 1} {C}_{ps 1} - 1} - \frac{1}{{ω}_{sp} {C}_{ps}} + {ω}_{sp} {L}_{p} = 0$$

And the impedance of tank 24 (Lₚₚ₁ and Cₚₚ₁) is infinity:

$$\frac{{ω}_{sp} {L}_{pp 1}}{1 - {ω}_{sp}^{2} {L}_{pp 1} {C}_{pp 1}} = ∞ = > 1 - {ω}_{sp}^{2} {L}_{pp 1} {C}_{pp 1} = 0$$

For the secondary 40, the impedances S₁=S₂=S₃:

$${ω}_{sp} {L}_{ss} = {ω}_{sp} {L}_{s} - \frac{1}{{ω}_{sp} {C}_{ss}} - \frac{{ω}_{sp} {L}_{ss 1}}{{ω}_{sp}^{2} {L}_{ss 1} {C}_{ss 1} - 1} = \frac{1}{{ω}_{sp} {C}_{sp}} + \frac{1}{{ω}_{sp} {C}_{2 ( sp )}}$$

$$where$$

$${C}_{1 ( sp )} = \frac{{ω}_{sp}^{2} {L}_{sp 1} {C}_{sp 1} - 1}{{ω}_{sp}^{2} {L}_{sp 1}}$$

$$and$$

$${C}_{2 ( sp )} = \frac{{ω}_{sp}^{2} {L}_{sp 2} {C}_{sp 2} - 1}{{ω}_{sp}^{2} {L}_{sp 2}}$$

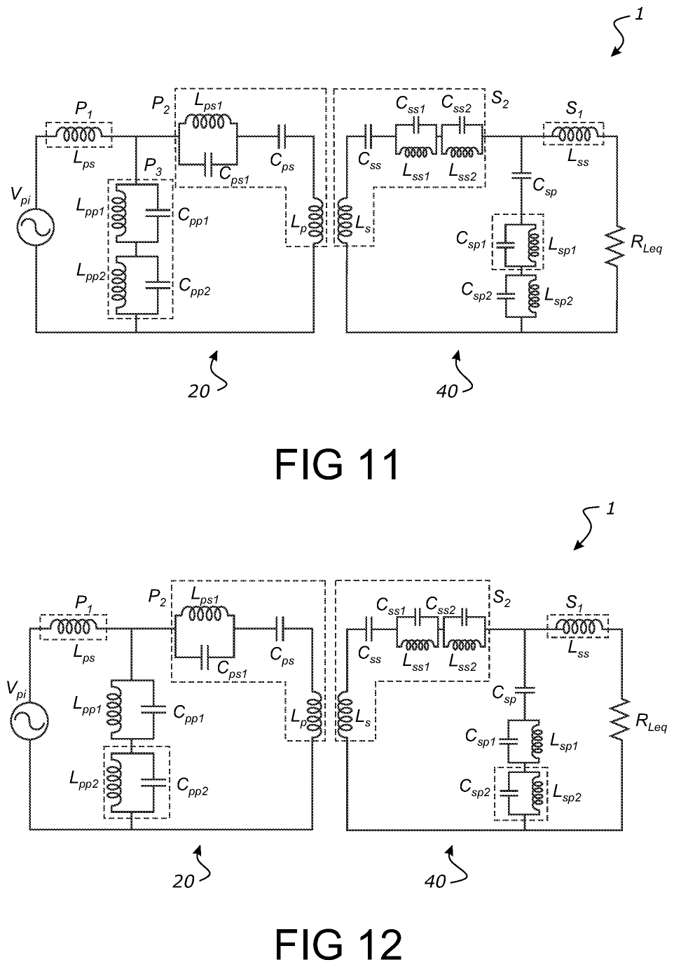

Referring to FIG. 11, a P-S mode of operation at an operating frequency (f_{P-s}, ωPS) is achieved for the primary 20 by making impedances P₁=P₂ P=P₃:

$${ω}_{ps} {L}_{ps} = {ω}_{ps} {L}_{p} - \frac{1}{{ω}_{ps} {C}_{ps}} - \frac{{ω}_{ps} {L}_{ps 1}}{{ω}_{ps}^{2} {L}_{ps 1} {C}_{ps 1} - 1} = \frac{1}{{ω}_{ps} {C}_{1 ( ps )}} + \frac{1}{{ω}_{ps} {C}_{2 ( ps )}}$$

$$where$$

$${C}_{1 ( ps )} = \frac{{ω}_{ps}^{2} {L}_{pp 1} {C}_{pp 1} - 1}{{ω}_{ps}^{2} {L}_{pp 1}}$$

$$and$$

$${C}_{2 ( ps )} = \frac{{ω}_{ps}^{2} {L}_{pp 2} {C}_{pp 2} - 1}{{ω}_{ps}^{2} {L}_{pp 2}}$$

For the secondary 40, the impedance of tank 48 (Lₛₚ₁ and Cₛₚ₁) is infinity:

$$\frac{{ω}_{ps} {L}_{sp 1}}{1 - {ω}_{ps}^{2} {L}_{sp 1} {C}_{sp 1}} = ∞ = > 1 - {ω}_{ps}^{2} {L}_{sp 1} {C}_{sp 1} = 0$$

Referring to FIG. 12, an S-S mode of operation at an operating frequency (f_{S-S}, ωSS) is achieved for the primary 20 by making the impedance of (P₁+P₂)=zero, so:

$${ω}_{ss} {L}_{ps} = \frac{{ω}_{ss} {L}_{ps 1}}{{ω}_{ss}^{2} {L}_{ps 1} {C}_{ps 1} - 1} - \frac{1}{{ω}_{ss} {C}_{ps}} + {ω}_{ss} {L}_{p} = 0$$

And making the impedance of tank 24′ (Lₚₚ₂ and Cₚₚ₂) infinity:

$$\frac{{ω}_{ss} {L}_{pp 2}}{1 - {ω}_{ss}^{2} {L}_{pp 2} {C}_{pp 2}} = ∞ = > 1 - {ω}_{ss}^{2} {L}_{pp 2} {C}_{pp 2} = 0$$

For the secondary 40, The impedance of (S₁+S₂) is zero:

$${ω}_{ss} {L}_{ss} = \frac{{ω}_{ss} {L}_{ss 1}}{{ω}_{ss}^{2} {L}_{ss 1} {C}_{ss 1} - 1} - \frac{{ω}_{ss} {L}_{ss 2}}{{ω}_{ss}^{2} {L}_{ss 2} {C}_{ss 2} - 1} - \frac{1}{{ω}_{ss} {C}_{ss}} + {ω}_{ss} {L}_{s} = 0$$

And the impedance of tank 48′ (Lₛₚ₂ and Cₛₚ₂) is infinity:

$$\frac{{ω}_{ss} {L}_{sp 2}}{1 - {ω}_{ss}^{2} {L}_{sp 2} {C}_{sp 2}} = ∞ = > 1 - {ω}_{ss}^{2} {L}_{sp 2} {C}_{sp 2} = 0$$

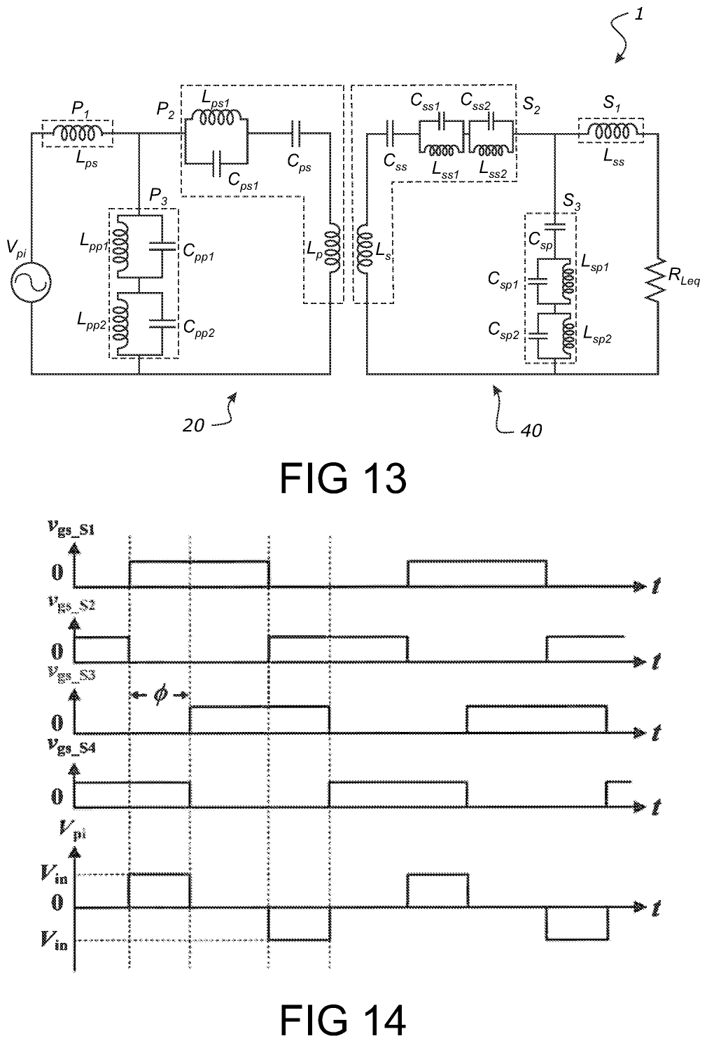

Referring now to FIG. 13, the P-P operation mode at operating frequency (f_{P-P}, ωPP) is achieved for the primary by impedances P₁=P₂=P₃:

$${ω}_{pp} {L}_{ps} = {ω}_{pp} {L}_{p} - \frac{1}{{ω}_{pp} {C}_{ps}} - \frac{{ω}_{pp} {L}_{ps 1}}{{ω}_{pp}^{2} {L}_{ps 1} {C}_{ps 1} - 1} = \frac{1}{{ω}_{pp} {C}_{p 1 ( pp )}} + \frac{1}{{ω}_{pp} {C}_{p 2 ( pp )}}$$

$$where$$

$${C}_{p 1 ( pp )} = \frac{{ω}_{pp}^{2} {L}_{pp 1} {C}_{pp 1} - 1}{{ω}_{pp}^{2} {L}_{pp 1}}$$

$$and$$

$${C}_{p 2 ( pp )} = \frac{{ω}_{pp}^{2} {L}_{pp 2} {C}_{pp 2} - 1}{{ω}_{pp}^{2} {L}_{pp 2}}$$

For the secondary, the impedances S₁=S₂=S₃:

$${ω}_{pp} {L}_{ss} = {ω}_{pp} {L}_{s} - \frac{1}{{ω}_{pp} {C}_{ss}} - \frac{{ω}_{pp} {L}_{ss 1}}{{ω}_{pp}^{2} {L}_{ss 1} {C}_{ss 1} - 1} - \frac{{ω}_{pp} {L}_{ss 2}}{{ω}_{pp}^{2} {L}_{ss 2} {C}_{ss 2} - 1} = \frac{1}{{ω}_{pp} {C}_{sp}} + \frac{1}{{ω}_{pp} {C}_{s 1 ( pp )}} + \frac{1}{{ω}_{pp} {C}_{s 2 ( pp )}}$$

$$where$$

$${C}_{s 1 ( pp )} = \frac{{ω}_{pp}^{2} {L}_{sp 1} {C}_{sp 1} - 1}{{ω}_{pp}^{2} {L}_{sp 1}}$$

$$and$$

$${C}_{s 2 ( pp )} = \frac{{ω}_{pp}^{2} {L}_{sp 2} {C}_{sp 2} - 1}{{ω}_{pp}^{2} {L}_{sp 2}}$$

Component values for the circuit of FIG. 9 may be determined for example by setting the frequency of S-P, P-S, S-S, and P-P as 79 kHz, 83 kHz, 87 kHz, and 90 kHz, respectively. On the primary, by using the formulas above and choosing Lₚ as 200 μH, the value of Lₚₛ, Lₚₛ₁, Cₚₛ₁, and Cₚₛ can be obtained. Then, the value of Lₚₚ₁, Cₚₚ₁, Lₚₚ₂, and Cₚₚ₂ can be obtained.

On the secondary, from choosing Lₛ as 200 μH, Lₛₛ as 50 μH, and Lₛₛ₂ as 1 μH, the value of Cₛₛ, Lₛₛ₁, Cₛₛ₁, and Cₛₛ₂ can be obtained. Then, with choosing Lₛₚ₂ as 0.5 μH, the value of Cₛₚ, Lₛₚ₁, Cₛₚ₁, and Cₛₚ₂ can be obtained. Table 2 below provides calculated component values for the circuit of FIG. 9.

TABLE 3

| Parameter | Symbol | Value | Unit |
|---|---|---|---|
| Rated power | P_{rated} | 1 | kW |
| Input DC voltage | Vᵢₙ | 160 | V |
| S-P operation frequency | f_{S-P} | 79 | kHz |
| P-S operation frequency | f_{P-S} | 83 | kHz |
| S-S operation frequency | f_{S-S} | 87 | kHz |
| P-P operation frequency | f_{P-P} | 90 | kHz |
| Primary pad self-inductance | L_{P} | 200 | μH |
| Primary series inductor | Lₚₛ, Lₚₛ₁ | 16.62, 1.14 | μH |
| Primary series capacitor | Cₚₛ, Cₚₛ₁ | 0.018, 3.05 | μF |
| Primary parallel inductor | Lₚₚ₁, Lₚₚ₂ | 2.42, 0.59 | μH |
| Primary parallel capacitor | Cₚₚ₁, Cₚₚ₂ | 1.68, 5.61 | μF |
| Secondary pad self- | Lₛ | 200 | μH |
| inductance | | | |
| Secondary series inductors | Lₛₛ, Lₛₛ₁, Lₛₛ₂ | 50, 1.21, 1 | μH |
| Secondary series capacitors | Cₛₛ, Cₛₛ₁, Cₛₛ₂ | 0.023, 3.08, 3.38 | μF |
| Secondary parallel inductor | Lₛₚ₁, Lₛₚ₂ | 0.16, 0.5 | μH |
| Secondary parallel | Cₛₚ, Cₛₚ₁, Cₛₚ₂ | 0.075, 23.71, 6.69 | μF |
| capacitors | | | |

Following on from the discussion above in relation to FIGS. 4 and 5, the same principles apply in determining the values of the components in order to provide the required resonant compensation at the different operating frequencies. It can be seen that one of the tanks 24, 24′ and 48, 48′ in each of the respective parallel branches can be made to resonant to provide a series compensation network, and the series tank 26, 46, 46′ in either circuit can be used together with the other series connected components to tune the circuit at either of the two frequencies at which series compensation is provided. Similarly, when parallel compensation is required, the two tanks 24, 24′ and 48, 48′ in each of the networks 20 or 40 are configured to provide a first overall impedance in the parallel branch which is suitable for resonance with the series connected reactive components for providing a first parallel compensation network at a first frequency and a second overall impedance in the parallel branch which is suitable for resonance with the series connected reactive components for providing a second parallel compensation network at a second frequency.

Having provided examples of compensation circuit topologies, control apparatus and methods for controlling power transfer using the novel topologies will now be disclosed. Under Lₚ and Lₛ coil misalignments, the output power of system 1 can be regulated by phase-shift modulation (PSM) of the H-bridge converter 22 on the primary. FIG. 14 shows the waveforms of PSM. The symbol V_{gs} is the gate driver signal imposed to the corresponding power switches S₁-S₄. The phase-shift angle (¢) between S₁ and S₃ determines the duty-ratio of Vₚᵢ. The RMS value (V_{pi,rms}) of Vₚᵢ at the fundamental frequency for the PSM is expressed as:

$${V}_{pi . rms} = \frac{2 \sqrt{2}}{π} {V}_{in} sin \frac{ϕ}{2}$$

By changing ¢, the primary input voltage can be controlled to regulate the output power using phase-shift modulation. Therefore, as M changes, the primary converter phase-shift angle can be varied to control and thereby regulate the output power. M is usually expressed in terms of coupling factor k, given by:

$$k = \frac{M}{\sqrt{{L}_{p} {L}_{s}}}$$

Large misalignments of Lp and Ls result in low k. We propose a control strategy in which k is detected, or estimated or inferred, and based on the value of k, an operating frequency is chosen for one of the circuits disclosed above whereby a topology (e.g. S-P) is invoked which is suitable for efficient power transfer for that value of k. As the value of k changes the phase shift angle is controlled to maintain or regulate output power until k changes to an extent at which use of an alternative compensation topology would be more efficient. At this point the primary converter changes to another operating frequency which corresponds to the alternative compensation topology.

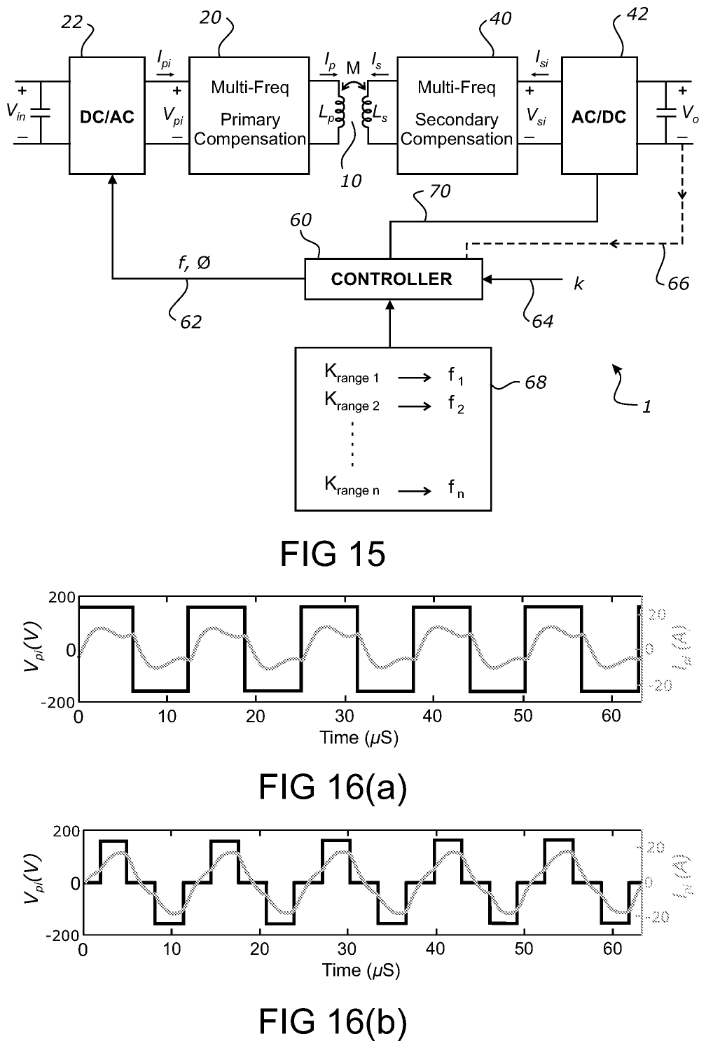

Referring to FIG. 15, a system 1 according to an example or embodiment is shown having compensation circuits 20 and 40 that are tuned to resonate at a plurality of operating frequencies, as described earlier in this disclosure. A controller 60 which may for example comprise a microcontroller or a processor is configured to control phase shift angle c dependent on an input which is representative of kin order to control output Vo. Controller 60 may have an output 62 which provides signals or data required to operate the switches of converter 22 to provide the phase angle (and thus control Vpi) at a selected operating frequency. Controller 60 has an input 64 for a signal or data representative of k. The input 64 may be derived by a number of different methods and/or from different sources. For example, and indication of k may be derived from knowing the physical position of the coil Ls and inferring k from that data. Another example is measuring the current and/or voltage or a phase relationship between these at a point on the secondary and/or at the primary, for example the currents and voltages going into or out of the compensation networks.

Controller 60 may also have an input 66 that provides a signal or data representative of the system output, so that a feedback loop can be provided to control one or more output parameters, such as output power. Input 66 can be derived from data passed back through the magnetic coupling between the power transfer coils Lp and Ls for example but can also be inferred from other properties of the system. For example, parameters such as voltage and current of the primary may allow the output power to be inferred for control purposes.

Secondary power control 42 may be an active rectifier or controller, for example comprising an H-bridge which is similar or the same as converter/inverter 22. This may allow the system 1 to be bidirectional. The converter 42 may be controlled to allow impedance matching between the primary and secondary sides of system 1. Controller 60 may also optionally have an input or input/output 70 to enable control of converter 42 to provide impedance matching and/or bidirectional operation.

Controller 60 may also be configured to change to a different discrete operating frequency in order to induce a change in compensation topology as described earlier in this disclosure. For example, as k changes to a level which is unsuitable or less efficient for power transfer using one compensation topology, for example S-P compensation, the controller can cause the system to switch to a more suitable topology, for example P-P compensation, by changing the system operating frequency to the frequency at which the compensation networks 20 and 40 form a P-P compensation network. In some examples, information as to various ranges of k that are appropriate for the different compensation topologies that may be formed by the system can be linked to the appropriate operating frequencies at which the topologies are formed using a table, such as table 68 in FIG. 15, which may be provided in a memory for example. Therefore, as k moves within various ranges, the controller changes the operating frequency f accordingly.

Examples of simulations using the circuit of FIG. 4 (a) and Table 1 are set forth below to further illustrate operation of the systems disclosed herein.

The simulated results of a 1 kW IPT system verify that the proposed system can be switched between at least two different compensation topologies to operate as fully tuned, based on the frequency of operation. In the simulated system, Vᵢₙ is set as 160 V, which is sourced from the 110 V AC supply. The tuning frequency for S-P is designed at 79 kHz and that for the P-P is designed at 85 kHz to meet the J2954 standard.

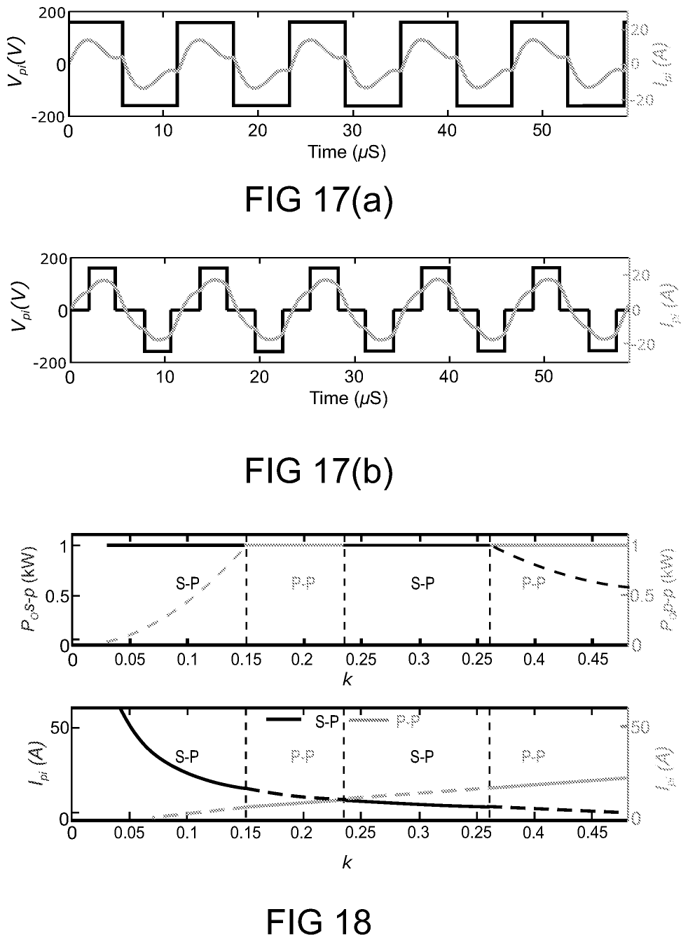

The parameters of this simulated IPT system are shown in Table 1. FIG. 16 demonstrates the simulated waveforms of S-P compensated system (79 kHz). FIG. 16 (a) and (b) show the condition when k is 0.36 and 0.24, respectively. The phase-shift angle ¢ is decreased to maintain the output power (P_{oS-P}) when large misalignments occur (low k). FIG. 17 demonstrates the simulated waveforms when the system operates at 85 kHz as P-P compensated. FIGS. 17 (a) and (b) show the condition when k is 0.15 and 0.22, respectively. It is evident that when topology operates as P-P compensated, ¢ must increase to keep the output power (Pop-p) at 1 kW at low values of k.

FIG. 18 demonstrates variation of P_{oS-P} and P_{oP-P} and lₚᵢ of S-P and P-P with k of the simulated system referred to above. It is apparent that when k is less than 0.15, P_{oP-P} cannot be maintained at 1 kW because ¢ is 180° as lₚᵢ is continuously decreasing with the decrease ink. Thus, the system operates as S-P compensated when k is low to provide the required power. In the range that k is 0.15 to 0.23, the system switches to P-P compensation due to the lower lₚᵢ, retaining higher efficiency. In contrast, in the range that k is 0.23 to 0.36, the system operates at S-P compensation according to lower lₚᵢ. When the k is larger than 0.36 (high k), the S-P compensation is not able to maintain required power due to low lₚᵢ and the limited ¢. The system thus switches to P-P compensation to fulfill the output power of 1 kW.

According to the frequency of the operation, the proposed reconfigurable topology can switch between S-P and P-P compensation to maintain 1 kW power. In the staggered range, the system chooses to operate with the compensation with lower lₚᵢ to achieve high efficiency. At high k, the system operates with P-P compensation, and at low k with S-P compensation, extending the operating range under wide pad misalignments. The simulated waveforms also show that the system can be operated as fully tuned in both S-P and P-P.

The control approach disclosed above is equally applicable with S-S and P-S reconfigurable compensation topologies as described for example in FIGS. 5 and 9.

The foregoing discloses a new reconfigurable compensation topology with control at multiple different operating frequencies for pad misalignments in inductive power transfer (IPT) systems. At different frequencies of operation, at least one topology can form either a S-P or P-P compensation network. Other topologies disclosed herein can additionally or alternatively perform P-S and S-S compensation topologies. The proposed topologies can be operated as fully tuned (resonant) in each type of compensation, based on the frequency and selection of the parameter values. According to simulations, the tolerance to pad misalignment can be improved in the proposed IPT system at least by switching to S-P compensation when k is lower than 0.15 and to P-P compensation when k is higher than 0.36. The simulated results also show the operating range to misalignment can be extended by applying to other reconfigurable compensation topologies.

1. A wireless power transfer resonant circuit comprising:
a power transfer coil; and
a compensation network connected between the power transfer coil and a power input or power output, the compensation network being configured to resonate with the power transfer coil at a first resonant operating frequency and a second resonant operating frequency;
the compensation network comprising a first tank circuit connected in series with the power transfer coil and a second tank circuit connected in parallel with the power transfer coil;
wherein the circuit forms a first parallel or series tuned compensation network topology at the first resonant operating frequency and a second parallel or series tuned compensation network topology at the second resonant operating frequency.

2. The circuit of claim 1 wherein the circuit forms a first parallel tuned compensation network topology at the first resonant operating frequency and a second parallel tuned compensation network topology at the second resonant operating frequency.

3. The circuit of claim 2 wherein the compensation network further comprises a series inductor connected in series with the first tank circuit, and the second tank circuit is connected between the first tank circuit and the series inductor.

4. The circuit of claim 3 wherein the first tank circuit or the second tank circuit is configured to have a capacitive impedance at the first resonant operating frequency.

5. The circuit of claim 3 wherein the first tank circuit or the second tank circuit is configured to have a capacitive impedance at the second resonant operating frequency.

6. The circuit of claim 1 further comprising a capacitor Cₛₛ connected in series with the first tank circuit.

7. The circuit of claim 1 further comprising a capacitor Cₛₚ connected in series with the second tank circuit.

8. The circuit of claim 1 further comprising a third tank circuit connected in series with the first tank circuit and a fourth tank circuit connected in series with the second tank circuit.

9. The circuit of claim 1 further comprising a fourth tank circuit connected in series with the second tank circuit and wherein the circuit forms a first series tuned compensation network topology at the first resonant operating frequency and a second series tuned compensation network topology at the second resonant operating frequency.

10. The circuit of claim 9 wherein one of the second or fourth tank circuits is configured to form an infinite impedance at the first resonant operating frequency to form the first series tuned compensation network, and the other of the second or fourth tank circuits is configured to form an infinite impedance at the second resonant operating frequency to provide the second series tuned compensation network.

11. The circuit of claim 1 wherein one or more of the tank circuits comprises a parallel tank.

12. A wireless power transfer primary or secondary circuit comprising the wireless power transfer resonant compensation circuit of claim 1.

13. A wireless power transfer system comprising the primary and/or secondary according to claim 11.

14. A wireless power transfer system comprising a primary resonant power transfer circuit and a secondary resonant power transfer circuit, the system being configured to operate at a plurality of different operating frequencies, each circuit being resonant at each operating frequency and wherein the primary circuit forms a first series tuned compensation network at a first of the operating frequencies and forms a first parallel tuned compensation network at a second of the operating frequencies, and the secondary circuit forms a first parallel tuned compensation networks at the first operating frequency and forms a second parallel tuned compensation network at the second of the operating frequencies.

15. The system of claim 14 wherein primary forms a second series tuned network at a third operating frequency and the secondary forms a first series tuned network at the third frequency.

16. The system of claim 14 wherein the secondary forms a second series tuned network at a fourth frequency and the primary forms a second parallel tuned network at the fourth frequency.

17. (canceled)

18. (canceled)

19. (canceled)

20. A method of controlling a wireless power transfer circuit, the method comprising:
determining a coupling factor for the wireless power transfer circuit;
selecting an operating frequency from a plurality of discrete operating frequencies at which the circuit is tuned to be resonant dependent on the coupling factor;
controlling the circuit at the selected operating frequency.

21. The method of claim 20 wherein each operating frequency to selected to implement a different compensation topology.
